(19) United States
(12) Patent Application Publication
(10) Pub. No.: US 2011/0027527 A1
(43) Pub. Date: Feb. 3, 2011

(54) Device and method for folding a paper article

(75) Inventor: Michael Trachsler, Wernetshausen (CH)

Correspondence Address: RANKIN, HILL & CLARK LLP, 38210 GLENN AVENUE, WILLOUGHBY, OH, 44094-7808, US

(73) Assignee: FERAG AG, Hinwil (CH)

(21) Appl. No.: 12/849,248

(22) Filed: Aug. 3, 2010

(30) Foreign Application Priority Data
Aug. 3, 2009 (CH) 1210/09

(51) Int. Cl. B32B 3/04; B31F 1/10

(52) U.S. Cl. 428/130; 493/416

(57) ABSTRACT

A device for folding a multi-sheet paper article that includes conveyor means for conveying the paper article in a direction of conveyance (F1), folding members for pushing the paper article to the conveyor means, guides, which are arranged on either side of the folding members for enveloping the paper article around the folding members, wherein the folding members define folding ridges which, as seen in the direction of conveyance, run side by side and thereby in the direction of conveyance define a gap between the folding ridges. Therein, as seen in the direction of conveyance, a width (b, b′, b″, b″′) of the gap between the folding ridges progressively narrows.

### BACKGROUND OF THE INVENTION

1. Field of the Invention

The invention pertains to the field of processing paper articles, in particular print shop products. The invention relates to a device and a method for folding a planar product, in particular a paper article, as well as a folded paper article according to the preamble of the corresponding independent claims.

2. Description of Related Art

One such device and a method are, for example, disclosed in DE 28 42 226 (corresponding to: U.S. Pat. No. 4,265,437): a multi-sheet newspaper, which is shown with a transverse break, is folded with a further longitudinal fold, wherein at one inner fold a counter kink or counter fold is created, which comprises a curvature, resp. a flexion, which is contrary to the curvature of the fold to be created (on the outer side). To this end, the device comprises multiple pairs of coaxial folding presses, at the circumference of each of which a folding ridge is formed and which are separated from one another by a space. The folding presses push upon the product, during which it is folded against the folding presses, wherein the counter kink is formed in the space between the folding presses. It is seen, however, that the method in the case of specific circumstances, for example with thick, multi-sheet products, that overloading may occur in the area of the inner side of the fold. It, thus, arises that as is shown schematically in FIG. 1, un-defined and uncontrollable creases can occur which radiate like spokes from the crossing point of the last fold (often called “Post-fold”) and the penultimate fold (often called the “transverse break”).

EP 0 413 371 B1 discloses different variants of pressure rollers by which a printed product is folded. In an embodiment one such roller is powered, to which end a groove is formed in the roller, in which a drive belt lies. Hence between the folding ridges at the circumference of the roller, a gap exists (thus the groove for the drive belt), this is however not provided to generate a counter-fold (FIG. 11). In another embodiment the roller is not driven and also features no groove (FIG. 12).

DE 23 30 513 shows a folding group in which a product is folded by a belt which is conveyed along a row of rollers and moves with the product in the direction of conveyance. The belt runs along the whole area in which the product is bent. A counter-fold is not intended.

DE 571 796 discloses a device for folding sheets by means of bending the half-sheets. Profiled rollers are present to hold down the sheets. An angle of the profile of this roller matches along the direction of conveyance with the diminishing angle between the sheet halves. A counter-fold is also not intended here.

EP 0 415 077 shows a folding device which generates, in a sheet material, a first fold in its direction of movement and a second fold in the transverse direction. Adjacently via an arrangement of belts a third fold is made, again in the direction of movement, wherein the sheet material moves through the folding device continuously and without stopping.

### BRIEF SUMMARY OF THE INVENTION

It is therefore an object of the invention to create a device and a method for folding a planar product, in particular a paper article of the kind mentioned above, which eliminates the disadvantages mentioned above. A further object is to prepare a corresponding cleanly folded paper article.

This object is achieved by a device and a method for folding a planar product, in particular a paper article, as well as a folded, in particular multi-sheet, paper article with the characteristics of the corresponding independent claims.

The device for folding a planar product, in particular a paper article, thus comprises:
conveyor means for the conveyance of the paper article in a direction of conveyance F1,
a folding member for pressing the paper article to the conveyor means,
guides, which are arranged on either side of the folding member, for enveloping the paper article around the folding member,
wherein the folding member defines folding ridges, or rather folding ridges are formed on the folding member,
   Thereby a space between the folding ridges progressively or continuously narrows, as seen in the direction of conveyance.

As seen in the direction of conveyance, the folding ridges run side by side and thereby define a gap formed in the direction of conveyance between the folding ridges. The gap thus comprises a decreasing width in the direction of conveyance, corresponding to the spacing of the folding ridges.

In the method, the planar products, in particular paper articles are conveyed through the middle of the device and enveloped around the folding member, wherein a longitudinal fold is formed. In the gap between the folding ridges a counter-fold forms, with a curvature opposite to the curvature of the longitudinal fold. Through gradual squeezing-together of material which borders on the counter-fold, by means of the folding ridges which are arranged with a narrowing space (or rather the width of the gap) relative to one another the counter-fold is pressed into the gap in accordance with the enveloping of the paper article, and is pressed substantially flat.

The formation of the counter-fold thus occurs in a controlled manner. The folding conserves the folded product (material and, where appropriate, printed layout), and the products are easier to open on account of the better-defined folding. Thanks to the clean folding, the products also appear to be of higher quality. Moreover, by means of the invention it is possible to fold thin as well as thick products without requiring that the device first be adjusted.

It is possible to fold, with the device, both single products as well as a copy stream of paper products, in particular print shop products, as appropriate with a leading folded edge being the transverse fold.

Preferably, in the area of a transverse fold, a counter break or a notch is formed, in which the counter-fold merges into a counter-break valley fold which proceeds to the transverse fold. The counter-break valley fold runs in particular to an actual inflection point of the transverse fold, at which the outer part of the newly-formed longitudinal fold meets the transverse fold.

A standing unit for enveloping the paper articles around the folding member preferably features two guide elements which are arranged mirror-symmetrically about a central plane, which form guide surfaces for the enveloping of the paper articles. The guide surfaces wind approximately helically about a line which runs parallel to the future folded edges. In the area of the future folding ridges. In the area of the future folded edges, the objects are fixed by a pressure device between mutually cooperating pressure elements which function as folding members. The folding members are preferably also a part of the conveyor device and can serve for driving in the direction of conveyance. The pressure elements feature, for example, pressure rollers and folding rollers, which press the products in the area of the future folded edge against a counter element. This counter element is, for example, a driven circulating belt. The rollers are typically arranged in the middle plane of the standing unit and are turnable about an axis which is normal to the middle plane. Translatory displacements in a direction perpendicular to the direction of conveyance are possible for adjustments to the thickness of the products, wherein to this end the rollers elastically deform and are pushed back against the counter element by tension. The rollers are substantially stationary in a direction parallel to the direction of conveyance.

The folding rollers each have respectively two peripheral edges which function as folding ridges, which are separated from one another by the gap. Folding rollers which succeed each other in the direction of conveyance comprise a gap which narrows monotonically from roller to roller.

In other preferred embodiments of the invention, the folding members are not rollers, but rather belts which travel over deflection rollers and run along the ridge folds to the counter fold.

The folding rollers can be designed as single pieces, or multi-pieced. The material of the folding rollers can be a metal (steel, brass, aluminum, . . . ) or a hard plastic, or a combination of different materials can be used.

In another preferred embodiment of the invention, the folding rollers each comprise two roller halves, which respectively are turnable about a common axis, wherein the axes of the two roller halves are not coaxial, but rather (slightly) inclined with respect to the normal of a middle plane of the device. The roller halves are, thus, slightly skewed about an axis which runs in the middle plane and perpendicular to the conveying surface. In this way, a narrowing space (b, b′, b″, b″′) and respectively a tapering gap is formed between the peripheral edges of the two roller halves in the contact area of the roller pairs with the product. This matches the direction of the ridge fold to the counter fold.

The folded paper article is in particular a print shop product, preferably multi-paged, and comprises a transverse fold and a longitudinal fold executed subsequent to the transverse fold, in which at the inner side of the longitudinal fold an inner portion of the sheets is folded with a curvature contrary to the curvature of the longitudinal fold and a counter fold is formed. To this end, a notch or a counter break is present in an area between the transverse fold and the counter fold, in which the counter fold merges into a counter-break valley fold which continues to the transverse fold.

Further preferred embodiments of the invention arise from the dependent claims. To this end, characteristics of the method claims can be freely combined with those of the device claims, and vice-versa.

### BRIEF DESCRIPTION OF THE DRAWINGS

In the following the subject of the invention is described in more detail with reference to preferred embodiments which are depicted in the included drawings. Schematically are shown:

FIG. 1 a paper article folded according to the state of the art;

FIGS. 2a-2c views of a paper article folded according to the invention;

FIGS. 3a-3f a folding device according to the invention.

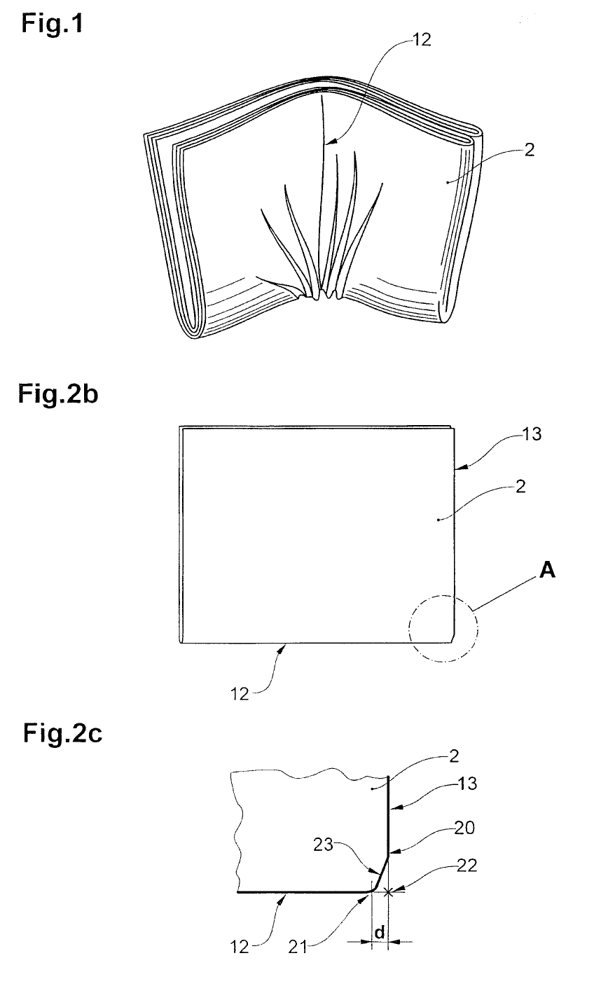

As a matter of principle, like parts are given the same reference numerals in the figures.

### DETAILED DESCRIPTION OF THE INVENTION

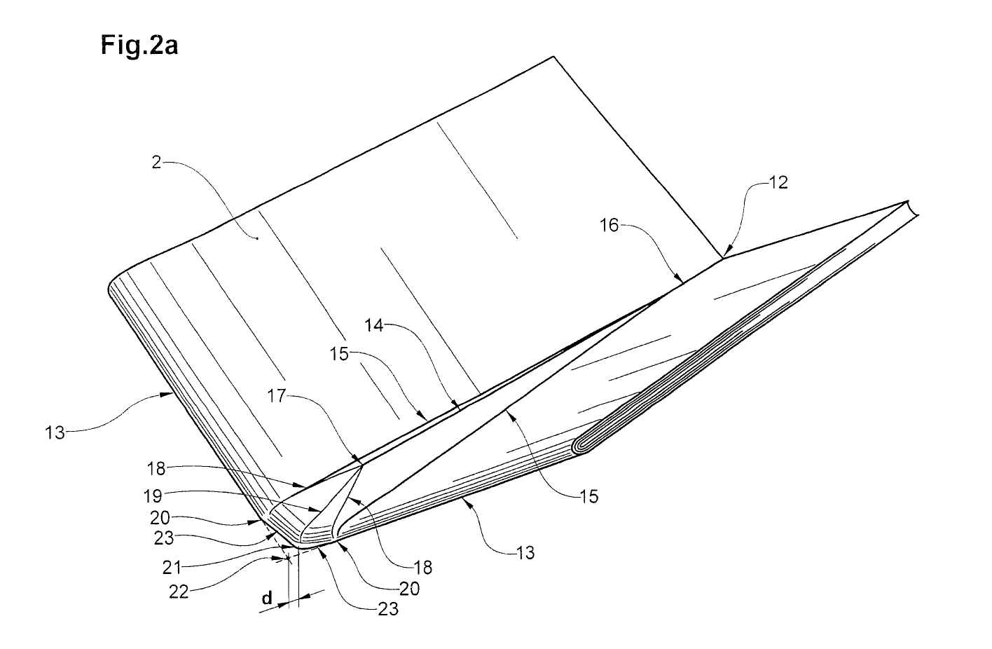

The FIGS. 2a, 2b and 2c show different views of a paper article folded according to the invention, in the following also called product 2. FIG. 2a shows schematically a view of a product 2 which has been partially opened again after being folded along a longitudinal fold 12. For the sake of a better representation, the folds on the inner side of the longitudinal fold 12 are depicted larger than they would occur in a typical product 2, for example in a folded newspaper.

The folded product shown is formed by folding at a transverse fold 13 and through subsequent folding at the longitudinal fold 12. Before the folding at the transverse fold 13, there can already be a first longitudinal fold (not shown here). In the folded product 2 two product halves are folded upwards at least approximately in the middle at the longitudinal fold 12. The product 2 lies symmetrically to a middle plane which runs through the longitudinal fold 12.

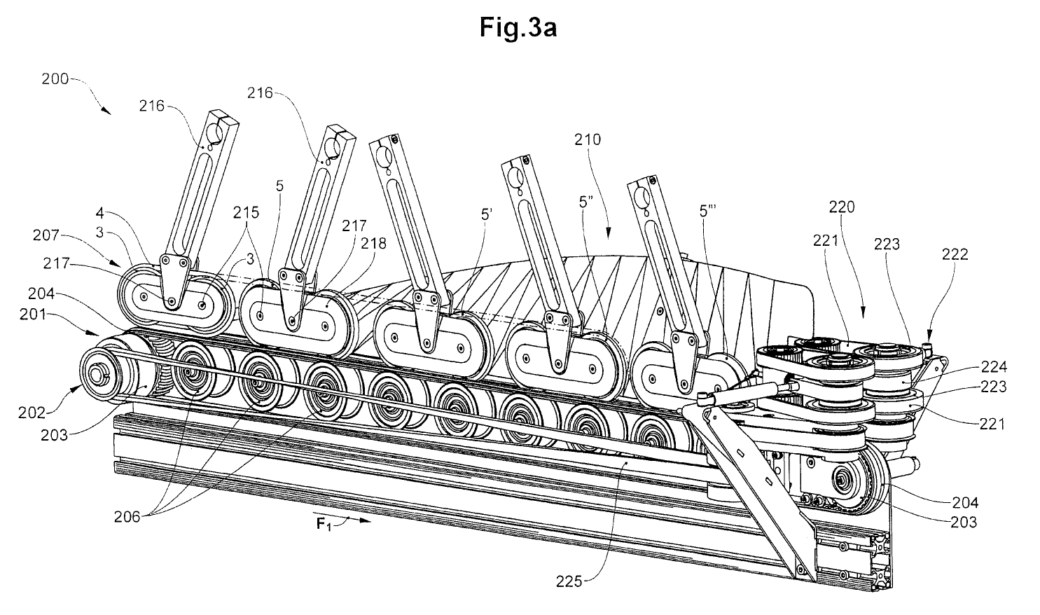

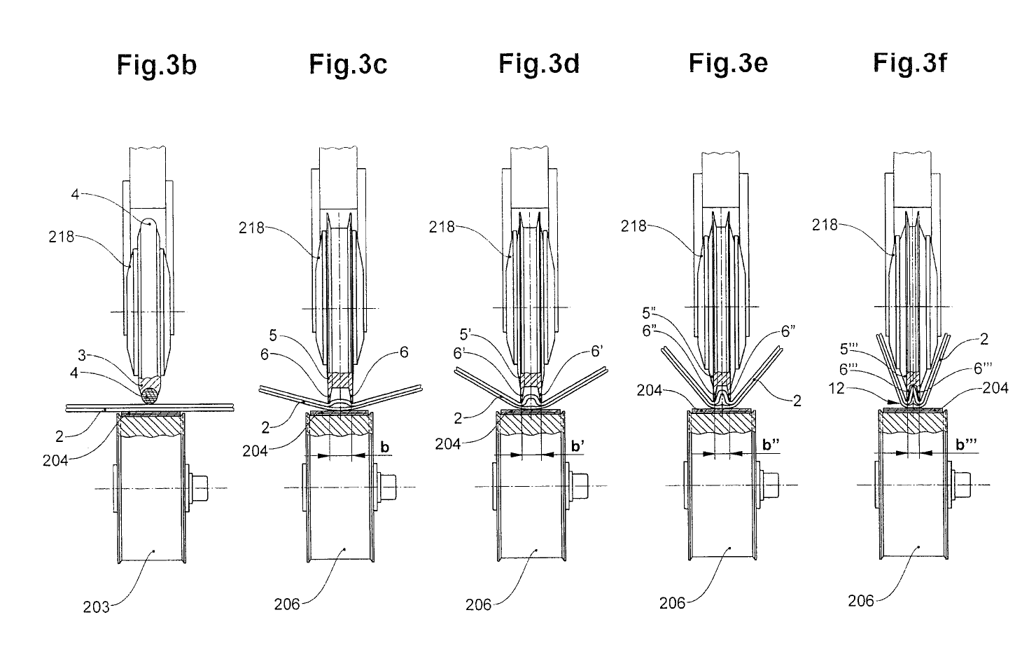

A lower, outer portion of the multiple sheets of the product forms a ridge fold as an outer part of the longitudinal fold 12 (not visible in FIG. 2a, but see FIGS. 3c-3f). As seen along the longitudinal fold 12, roughly between its middle and the end which meets the transverse fold 13, an upper, inner portion of the sheets is folded upwards and forms a counter fold 14. This forms a peak fold, its curvature is contrary to the curvature of the curvature of longitudinal fold 12 as a whole. Material planes which are adjacent to the counter fold 14 merge into the valley fold 15 of the counter fold 14 in the un-folded area of the inner side of the product.

At one side of the product 2, according to the material, thickness and size of the product 2, the counter fold 14 terminates at an endpoint 16, as it there meets its associated valley fold 15 at an acute angle. In the example of FIG. 2a, at the opposite side of the product 2, a transverse fold 13 is present. At the transition of the counter fold 14 to the transverse fold 13, a so-called counter break is present, this means that the counter fold 14 (which is a peak fold), is transformed at a corner 17 into a valley fold, in the following called a counter-break valley fold 19. The counter fold 14 and the counter-break valley fold 19 both lie in the middle plane. The counter-break valley fold 19 forms a transition between counter fold 14 and transverse fold 13. Counter-break peak folds 18 are present on both sides of the counter-break valley fold 19, which radiate from the corner 17, and which respectively form a transition between a plane adjacent to the counter fold 14 and a plane adjacent to the counter-break valley fold 19. The two counter-break peak folds 18 transition to the transverse fold 13 each at a respective counter-break kink 20.

If the sections of the transverse fold 13 in the two product halves which are folded against each other are imagined to extend, they would intersect the transverse fold at an ideal inflection point 22. Were the product to consist of a single sheet, then this would be the actual inflection point. However as a consequence of the product's thickness from the lower portion at the outer part of the longitudinal fold 12 to the upper portion which is folded into the counter fold 14, the length of the materials between corner 17 and the end of the counter-break valley fold 19 (at transverse fold 13) does not reach the ideal inflection point 22 of the transverse fold. The actual inflection point 21 of the transverse fold is thus somewhat pulled into the product 2 during folding, and is displaced from the ideal inflection point 22 by a difference or a space d. Depending on the properties of the product, the space amounts to more than one millimeter or more than two millimeters. Thereby segments 23 of the transverse fold 13, which lie between the actual inflection point 21 and the two counter break kink points 20 (in the following called counter break segments 23 of the transverse fold), are also curved or kinked inwards vis-à-vis the remaining segments of the transverse fold. This is further clarified by the side view of FIG. 2b and a corresponding detailed view 2c of the area A of FIG. 2b.

FIG. 3a depicts parts of a folding group 200 according to the invention, namely a conveyor device 202, a standing unit 210 for standing/folding of the products and a transfer unit 220 for further conveyance of products. The products themselves, an example press unit for pressing the folds and a depositing device for turning the folded, vertically standing products to a horizontal position are not shown.

The conveyor device 202 serves for conveying the products to be folded through the folding group 200. It features several sub-conveyors:

A first sub-conveyor 201 comprises a driven belt 204, which is wrapped around several rollers 203. The active run of the belt 204 defines a narrow conveyance surface, on which the products lie in the area of their future folded edge and are moved in direction of conveyance F1. The longitudinal fold 12 that is formed in the product thus lies parallel to the direction of conveyance. In the example shown, the belt 204 comprises curved gearing to maintain its centered position on the rollers 203, as can be seen on one of the rollers 203.

The products are pressed against the belt 204 by means of press rollers 3 and folding rollers 5, 5′, 5″, 5′″. This is stabilized from below by further rollers or supporting rollers 206. The supporting rollers are preferably arranged so that they respectively each correspond to a folding roller, i.e. that they lie opposite to the folding rollers with respect to the belt, wherein in each case a supporting roller lies across from a folding roller.

Belt 204, supporting rollers 206 and press rollers 3 form a pressing device 207 for fixing the future folded edges. The belt 204, and respectively the conveyance surface, can comprise a groove into which the products are pressed by the folding member. The press rollers 3 and folding rollers 5, 5′, 5″, 5″′ are mounted to holding means 216 about axes 215 which run perpendicular to the direction of conveyance F1. This allows a resilient yield of the press rollers 3 and folding rollers 5, 5′, 5″, 5″′ upwards, against gravity and/or a spring force (with pre-tension) yet without any substantial movement of the press rollers 3 and folding rollers 5, 5′, 5″, 5″′ in the direction of conveyance. Preferably, in each case two press rollers 3 are mounted in a single bearing body 218 which is mounted on a swivel axis 217 (which runs parallel to the axes 215 of the press rollers 3) and is moveable relative to the holding elements. The design of the press rollers 3 and folding rollers 5, 5′, 5″, 5″′ is described in more detail below in conjunction with FIGS. 3b-3f.

A second sub-conveyor 222 is integrated into the transfer unit 220 for the standing conveyance and guidance of the pre-folded products. It features a plurality of belts 221 looped around rollers 223, which are driven in opposing pairs. Between these a vertical conveyance gap for the products is formed. The rollers have a sprung support 224, such that the conveyance gap has a variable width. The second sub conveyor 222 is coupled with the drive for the first sub-conveyor 201 via a coupling element 225, here a further belt.

The standing unit 210 features two planar guide elements 212 arranged beside the belt 204, of which only one is shown here. The guide elements 212 are mirror-symmetric to a middle plane of the folding group 200, which is, as a rule, vertical. The guide elements function together in the manner of a folding funnel. They thus serve to bend the product halves of a product 2 upwards and toward one another on both sides of the fold 12 to be produced. Thereby, the longitudinal fold 12 of a product 2 is formed on the conveyance surface and in the direction of conveyance F1, and a middle plane of the product 2 lies in the middle plane of the folding group. At the entrance of the folding group 200, the guide faces 213 lie in the horizontal plane of conveyance and change their orientation as they travel further along, as they rise upwards and come together in a v-form. The guide faces 213 wind helically about a line which runs parallel to the future longitudinal fold 12.

Between the two guide elements 212 is a gap, in which the above-described pressure device 207, or as the case may be, the first sub-conveyor 201 operates.

The folded product 2 at the exit of the standing unit 210 is subsequently transferred to a transfer unit 220 and from its local sub-conveyor 222 further conveyed in a controlled manner in a vertical conveyance plane (middle plane), i.e. standing. The products 2 are transferred to a press unit in their standing position or as the case may be taken thereby in a controlled fashion.

FIGS. 3b-3f show in the direction of conveyance successively following press rollers 3 and folding rollers 5, 5′, 5″, 5″′, as well as their effect on the products 2. FIG. 3b shows a press roller 3 of a first roller set, which is surrounded by a press belt 4. The press belt 4 is shown as a round belt, but can also comprise a different form, for example a wedge or v-form. The press roller 3 of the first roller set pushes the products 2 against the belt 204, as preparation for the successive folding. The press belt 4 is made of an elastic material and thereby stabilizes irregularities in movement and position of the products 2.

The press belt 4 can also, as shown by dotted lines in FIG. 3a, not only run and be guided over the press rollers 2 but also over one or more of the folding rollers 5, 5′, 5″, 5″′. This improves the guidance of the products 2 and the synchronicity of the products 2: jolts are reduced or eliminated, the clamping between the press belt 4 and the belt 204 is improved.

FIGS. 3c-3f show folding rollers 5, 5′, 5″, 5″′ with a gap that narrows in the direction of conveyance F1. The gap lies in each of the folding rollers 5, 5′, 5″, 5″′ between two peripheral edges 6, 6′, 6″, 6″′ of the folding rollers. In the FIG. 3a not all of the folding rollers are shown with reference numerals and are associated with the FIGS. 3b-3f. The unspecified folding rollers comprise, preferably, a gap which in each case lies between that of the preceding roller and that of the subsequent roller. It can be, however, that immediately successive rollers comprise the same gap width.

The creation of the counter fold occurs as can be seen in the FIG. 3c, substantially as described in the above-mentioned DE-C 28 42 226, which is here included by reference in its entirety. As the product 2 is folded against the folding member, thus in the depiction upwards against the folding roller 5, the gap between the peripheral edges 6 allows that an overlaying part of the product 2 can yield upwards into the gap. In the figures, the product 2 is depicted schematically by two sheets, in reality however, the invention is appropriate for substantially bulky paper articles and can be used for dozens to hundreds of sheets which lie on top of one another and are to be folded together. If the product comprises a transverse fold 13, it enters into the folding group 200 as the leading edge.

The creation of the counter break in the counter fold occurs as follows: in contrast to DE-C 28 42 226, in which successive folding rollers comprise the same gap width as the first folding roller 5, here the gap narrows noticeably in successive folding rollers 5′, 5″, 5″′ (FIGS. 3d-3f), in accordance with the folding of both product halves. In this way the valley folds 15 of the counter fold 14 are folded towards one another (in a direction perpendicular to the direction of conveyance), and the counter fold 14 itself is pressed further together and upwards. The surfaces (depending on the material) between valley fold 15 and counter fold 14 are brought together rapidly and in a well-defined manner until they are nearly parallel. They form precise, sharp edges of the valley fold 15 and by the counter fold 14, in particular after the pressing of the folded product 2 in the subsequent press unit.

As a rule a transverse fold 13 is present in the product 2, as shown in FIG. 2a, whereby the cross section through the product 2, as shown in the FIG. 3f, can not be valid in the area of the transverse fold 13. The material of the product must also run in the area of the newly-formed longitudinal fold 12 around the transverse fold 13. It turns out that on this account that in the course of folding (FIGS. 3c-3f) the material in the area of the transverse fold automatically kinks, i.e. forms the counter break. The counter fold 14 thus devolves at the corner 17 into the counter-break valley fold 19, which runs to the transverse fold 13.

Because the corner 17 is folded upwards and thereby separated from a lower part of the longitudinal fold 12 which lies upon the belt 204, and because the length of the counter-break valley fold 19 cannot be increased by stretching the paper, the transverse fold 13 is pulled inward at the end of the counter-break valley fold 19. In this way, the difference d develops between the ideal inflection point 22 of the transverse fold 13 and the actual inflection point 21 of the transverse fold 13. In this way the counter break segment 23 of the transverse fold 13 also develops between the two counter-break kink points 20 and the actual inflection point 21 of the transverse fold 13.

The run-in of the valley folds 15 of the counter fold 14 (at the end point 16 of the counter fold) into the counter fold 14 is a consequence of the fact that the product 2 is somewhat thicker at the side of the transverse fold 13 than at the opposite side, due to the stiffness of multiple layers of paper. As the product is run through the folding rollers 5, 5′, 5″, 5″′ the pressure on the inner paper layers decreases in the thinner part of the product, and the need of forming these inner paper layers to the counter fold 14 decreases. Consequently the counter fold 14 is shallower and smaller as it runs to the end point 16. Depending on the dimensions and properties of the materials, the counter fold 14 can, however, not run out until it reaches the opposite side.

The depicted press rollers 3 and folding rollers 5, 5′, 5″, 5″′ are not driven, and turn with the driven belt 204. In other preferred embodiments of the invention some or all of these rollers can be driven.

1. A device for folding a planar product, in particular a paper article comprising:
conveyor means for conveying the paper article in a direction of conveyance,
folding members for pressing the paper article to the conveyor means,
guides which are arranged on either side of the folding member for enveloping the paper article around the folding member,
wherein the folding member defines folding ridges; and
wherein as seen in the direction of conveyance, a space (b, b′, b″, b″′) between the folding ridges progressively narrows.

2. The device according to claim 1, wherein the folding member comprises folding rollers and a folding roller respectively comprises two peripheral edges which act as folding edges, which are separated from one another by a gap, and wherein folding rollers that succeed each other in the direction of conveyance comprise a monotonically narrowing spacing (b, b′, b″, b″′) of the peripheral edges.

3. The device according to claim 1, wherein the folding rollers respectively comprise two roller halves, which respectively are rotatable about a single axle, wherein the rotation axes of the two roller halves are not coaxial, and are skewed with respect to the normal of a middle plane of the device, whereby—in the contact area with the product they form a narrowing space (b, b′, b″, b″′) between the peripheral edges of the two roller halves.

4. The device according to claim 1, wherein the conveyor means is a belt, which conveys the paper articles on its outer side and on its inner side comprises spiral teeth or v-teeth or longitudinal ribs for guiding of a diversion roller or driving roller.

5. The device according to claim 1, wherein at least a first press roller comprises no gap, and in particular comprises an elastically flexible layer in the circumferential area.

6. The device according to claim 1, wherein a first and a second press roller are connected together by means of an elastically flexible band which loops around the two folding rollers at their circumferential area.

7. The device according to claim 1, wherein the folding rollers are designed as single pieces.

8. The device according to claim 1, wherein at least one of the folding rollers turns freely, or wherein at least one of the folding rollers is propelled.

9. The device according to claim 1, wherein the folding member comprises multiple sets of folding rollers, each set having at least two folding rollers, wherein one such set is able to be pivoted about an axis which runs perpendicular to a middle plane of the device.

10. A method for folding a planar product, in particular a paper article comprising the steps of:
conveying of the paper article in a direction of conveyance (F1) by means of a conveyance means;
pressing the paper article to the conveyance means by means of folding members;
enveloping the paper articles around the folding members by means of guides which are arranged on either side of the folding members;
defining of folding ridges at the folding members;
wherein as seen in the direction of conveyance (F1), there is a progressively narrowing space (b, b′, b″, b′″) between the folding ridges.

11. The method for folding a multi-sheet paper article according to claim 10, comprising the step, during the enveloping of the paper article around the folding member of:
formation of a longitudinal fold as well as, at an inner side of the longitudinal fold a counter-fold with a curvature opposite to the curvature of the longitudinal fold;
gradual pushing-together of material which borders the counter-fold, by means of folding ridges which are arranged so that the width (b, b′, b″, b″′) of the gap between them progressively narrows.

12. The method for folding a multi-sheet paper article according to claim 10, further comprising the step of:
formation, in the area of a transverse fold a counter-break in which the counter-fold is transformed into a counter-break valley fold, which runs to the transverse fold; in particular to an actual inflection point of the transverse fold, at which the outer part of the newly-formed longitudinal fold and the transverse fold meet.

13. A folded paper article, in particular a print shop product, comprising a transverse fold and a longitudinal fold produced subsequent to the transverse fold, in which at the inner side of the longitudinal fold an inner portion of the sheets is folded with a curvature contrary to the curvature of the longitudinal fold and forms a counter fold, wherein at an area between the transverse fold and counter fold a counter break is present, in which the counter fold is transformed into a counter-break valley fold which runs to the transverse fold.

14. The folded paper article according to claim 13, wherein an intersection point between the longitudinal fold and the transverse fold, called the actual inflection point, is displaced along the longitudinal fold in the direction of the inner side of the product with respect to the remaining course of the transverse fold.

15. The folded paper article according to claim 14, wherein the actual inflection point is displaced to a distance (d) of more than one millimeter or more than two millimeters.
